(19) United States
(12) Patent Application Publication
(10) Pub. No.: US 2005/0283394 A1
(43) Pub. Date: Dec. 22, 2005

(54) Automated user evaluation and lifecycle management for digital products, services and content

(76) Inventors: Justin McGloin, Mountain View, CA (US); Patricia McGloin, Mountain View, CA (US); Leonardo Rub, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/128,867

(22) Filed: May 12, 2005

Related U.S. Application Data
(60) Provisional application No. 60/581,995, filed on Jun. 21, 2004.
(60) Provisional application No. 60/627,448, filed on Nov. 12, 2004.

(51) Int. Cl. G06F 17/60

(52) U.S. Cl. 705/10

(57) ABSTRACT

A user in an identified adoption group is periodically queried regarding use of a product. Results of the querying are received and evaluated. The evaluating includes aggregating the results by category, computing a proportion of total results for each category, and generating a first user emphasis vector based on the proportion of total results for each category. Based on the evaluating, a determination is made whether to incorporate the results of the querying into a representative result for an evaluation group.

### RELATED APPLICATIONS

This application is related to and claims the benefit of U.S. Provisional Patent Application 60/581,995 entitled “Automated User Evaluation and Lifecycle Management for Electronic Products and Services,” filed Jun. 21, 2004, the contents of which are incorporated by reference herein. This application is also related to and also claims the benefit of U.S. Provisional Patent Application 60/627,448 entitled “Automated User Evaluation and Lifecycle Management for Electronic Products and Services,” filed Nov. 12, 2004, the contents of which are incorporated by reference herein.

### TECHNICAL FIELD

The present invention relates generally to the automated user evaluation and lifecycle management of digital products, services and content.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the data as described below and in the drawings hereto: Copyright© 2004, Autolytics, Inc., All Rights Reserved.

### BACKGROUND INFORMATION

In theory, a product lifecycle is a sequence of stages through which a product passes, including: introduction, growth, maturity and sales decline. Tools which implement Product Lifecycle Management (PLM) are designed to enable and implement this theory across all parts of the value-chain including suppliers, customers and parts of the organization.

A bell curve, such as shown in FIG. 1, is often used to illustrate the adoption lifecycle of various technologies used to develop related products or services. Five different adoption groups are defined by the bell curve: Innovators, Early Adopters, Early Majority, Late Majority and Laggards. The adoption groups are characterized by various criteria including technology functions, features, usability, transparency, quality and pricing/value. In order for a product to cross from one adoption group to the next, it is theorized that the product needs to succeed in the previous adoption group plus address the additional requirements of the next adoption group. The largest such gap occurs between the Early Adopters and Early Majority groups.

With the Internet emerging as an important distribution channel, the proliferation of products and services has meant that competition has intensified and the lifespan of these products and services has become increasingly short as customers easily switch between competitors. This has meant that organizations in charge of the research, design, development, distribution, etc. have become increasingly challenged to understand customer needs and requirements in a timely manner and deliver products and services which meet these needs.

Traditionally, this type of task was accomplished through market research using surveys and focus groups to understand existing and potential customer needs. However, with dramatically shortened shelf-lives for many products, this kind of upfront investment, both in terms of cost and time, is no longer practical.

Furthermore, the challenge with many products which have been successfully launched to the marketplace has been to achieve significant penetration in the market. Frequently, products and services do not match the requirements of varying segments of the market, e.g., different adoption groups, and consequently remain niche products attractive only to a few customers interested in a specific technology or concept, but never reaching the majority of the market. In effect, where market penetration rates of 80% might be expected (assuming Laggards cannot be guaranteed to adopt a product/service), because most products/services never move from the Early Adopters to the Early Majority, they achieve less than 20% market penetration.

While market research may have helped somewhat here in the evolution of the product in the past, with the compression of product shelf lives and profits, traditional market research remains a prohibitively high overhead. In short, the biggest gap in the management of product and service lifecycles has always been between the customer and the organization. This problem has become compounded with the ease with which the Internet can now be used as a channel for distribution, further removing organization contact with the customer.

Most current product/service evaluations focus on models and surveys. However, the accuracy of modeling varies greatly depending on the model used as well as trends and changes in the marketplace. Similarly, surveys can suffer from accuracy problems as they tend to be ignored by most users, considered a nuisance and lacking an incentive, such as a free trial or evaluation, to even potentially interested users. Enterprises conducting surveys typically see response rates of 5% to 10%. In addition, survey data tends to be a time-specific snapshot making it difficult to monitor collected data for consistency and reliability.

### SUMMARY OF THE INVENTION

In one aspect of the invention, a user in an identified adoption group is periodically queried regarding use of a product. Results of the querying are received and evaluated. The evaluating includes aggregating the results by category, computing a proportion of total results for each category, and generating a first user emphasis vector based on the proportion of total results for each category. Based on the evaluating, a determination is made whether to incorporate the results of the querying into a representative result for an evaluation group.

In one aspect, evaluating the results includes correlating the first user emphasis vector with vectors for neighboring intervals of a lifecycle curve for the product. In another aspect, a vector is selected for the neighboring intervals with a high correlation to the first user emphasis vector. The first user emphasis vector is associated with a first adoption status for the product, the first adoption status corresponding to the selected vector. A first representative user emphasis vector is estimated for the first adoption status. In yet another aspect, a second representative user emphasis vector is estimated for a next adoption status for the product, based on the first user emphasis vector, the first adoption status, and the first representative user emphasis vector. In another aspect, the first representative user emphasis vector is corroborated with quantitative data of the identified adoption group.

The present invention is described in conjunction with methods, apparatuses and systems of varying scope. In addition to the aspects of the present invention described in this summary, further aspects of the invention will become apparent by reference to the drawings and by reading the detailed description that follows.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating the prior art technology adoption lifecycle.

FIG. 2 is a diagram illustrating an embodiment of PDS as a product lifecycle management solution.

FIG. 3 is a chart illustrating the relationship between the trend curves and calculated probability of customer adoption.

FIGS. 4A and 4B are charts illustrating trend curves used to determine product adoption status in the present invention.

FIG. 5 is a flowchart illustrating an embodiment of the evaluation participant selection process of the present invention.

FIG. 6 is a flowchart illustrating an embodiment of the feedback quality and trial control process of the present invention.

FIG. 7 is a flowchart illustrating an embodiment of the information prioritization process of the present invention.

FIG. 8 is a flowchart illustrating an embodiment of the participant feedback process of the present invention.

FIG. 9 is a diagram illustrating an embodiment of PDS as a product evaluation solution.

FIG. 10 is a diagram illustrating an embodiment of PDS as a solution for product marketing strategy creation and execution.

FIG. 11 is a diagram illustrating an embodiment of PDS as a product performance monitoring solution.

FIG. 12 is an architectural diagram depicting major PDS components.

FIGS. 13A and 13B are diagrams illustrating embodiments of PDS within a different data services environments.

FIG. 14 is a diagram illustrating an embodiment of the PDS Client-Server call flow.

FIG. 15 illustrates an embodiment of an operating environment suitable for practicing the present invention.

FIG. 16 illustrates an embodiment of a computer system suitable for use in the operating environment of FIG. 15.

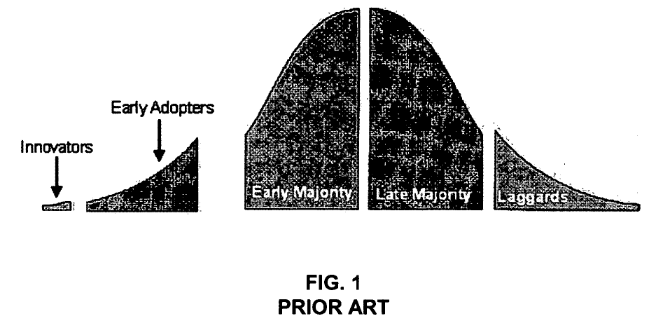

### DETAILED DESCRIPTION

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

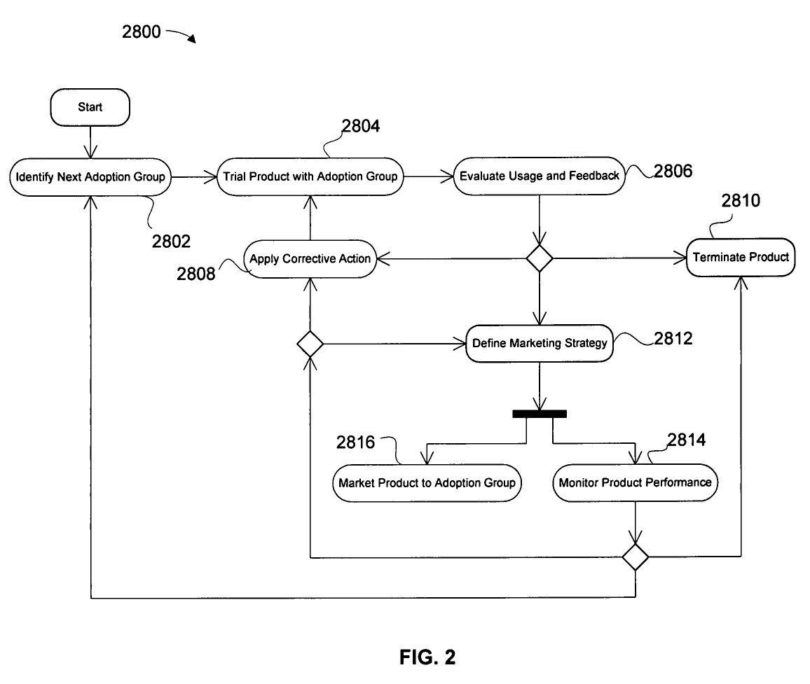

A Product Decision Support (PDS) system automates data collection and analysis tasks associated with product, service and content lifecycle management, including initial and ongoing customer evaluation, product and service performance tracking and management, and corrective action intelligence gathering. The PDS may be used to analyze products, technologies, services and/or content, which are collectively referred to herein as products. Thus it will be understood that, as used herein, reference to a “product” includes any of a product, a technology, a service, a content delivery or all of the above. FIG. 2 illustrates an embodiment of PDS 2800 used in an organization to provide effective product lifecycle management. The PDS workflow is an iterative process in which customers of varying points of adoption (the time period in which they are likely to purchase the product) are selected for evaluation. Evaluation data and feedback for the particular adoption group is analyzed and applied to execute an effective strategy for selling to a group of customers. In this way, the PDS is used to focus on delivering products and services to those prospective customers who are most likely to purchase the product in the near future (early point of adoption). As the product matures, and the adoption group changes, the requirements for the product are modified accordingly, as well as product marketing parameters such as pricing and promotion.

At block 2802, the first (or next) target adoption group is identified. A trial of the product is performed with the target adoption group at block 2804. At block 2806, an evaluation of the usage and feedback of the product is performed. Based on this evaluation, corrective action may be identified and applied to the product definition at block 2808, after which, the trial may be conducted again at block 2804. In another situation, the product may be terminated at block 2810 based on the evaluation performed at block 2806. In another situation, the evaluation from block 2806 may be used to define a marketing strategy at block 2812. Based on this marketing strategy, the product may be marketed to the target adoption group at block 2816. Simultaneously with the marketing of the product, the performance of the product in the marketplace may be monitored at block 2814. Based on this monitoring, at least one of the following actions may be taken: the product may be terminated (block 2810), further corrective action may be applied to the trial product (block 2808), the marketing strategy may be redefined (block 2812), or the PDS may shift its focus by identifying the next adoption group (block 2802).

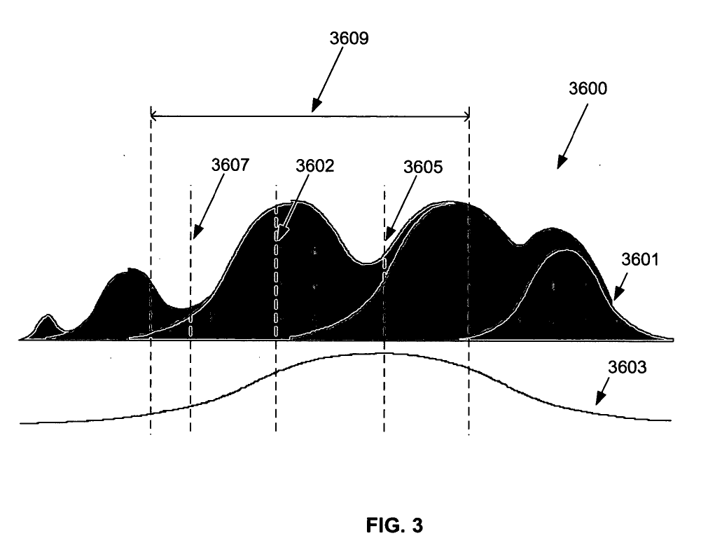

Referring to FIG. 3, the relationship between the trend curve 3601 for a Product A and probability function 3603 for a Customer X adopting product A is shown 3600. Customer X may be a current or former customer of a different product. Adoption Status S 3602 is defined as the estimated point on the product adoption lifecycle curve for Product A. Adoption Point P 3605 is defined as a point on the product adoption lifecycle curve where the probability that Customer X will adopt Product A is at its maximum. Alternatively, Adoption Point P 3605 can be defined as the point at which the probability that Customer X will adopt Product A is greater or equal to a selected threshold value T 3607. The Probability of Adoption is defined as a calculated probability of adoption of Product A by Customer X over a particular Interval 13609. Alternatively, the Probability of Adoption represents the probability of adoption of Product A by Customer X at Adoption Status S 3602.

In order to measure Adoption Status, Adoption Point and Probability of Adoption, the PDS uses the historic trends of related products and a target product evaluation data to develop an understanding of the state of customer adoption for the given product. To correctly identify adoption groups and corresponding Product Adoption Status, PDS weighs the customer emphasis. Customer emphasis corresponds to prioritized customer requirements for the product such as functionality, features, quality, pricing/value, usability and transparency (where the customer is unaware of the presence of the product possibly in a third-party product). The level of emphasis (e.g., level of importance or relevance) placed on each of these product characteristics helps to determine where the product is in its product lifecycle. A user of a product that participates in the product trial or product evaluation will be referred to as a participant. Through the gathering of participant feedback, the PDS is able to characterize participants. The PDS defines Innovators for a class of product as users who emphasize function over other considerations. Users who emphasize features as most important are characterized by PDS as Early Adopters. Users who emphasize at least one of product quality and pricing/value are characterized as belonging to the Early Majority. Users who emphasize usability as a primary concern in the purchasing of a product are considered to belong to the Late Majority. Users who show little or no interest and are more interested in transparency are considered to belong to the Laggards group in the product adoption lifecycle. It is also important to note that members from each adoption group may very well be characterized by one or more of these requirements with predetermined emphasis assigned to each one of these requirements. Therefore, PDS considers a customer's cumulative emphasis.

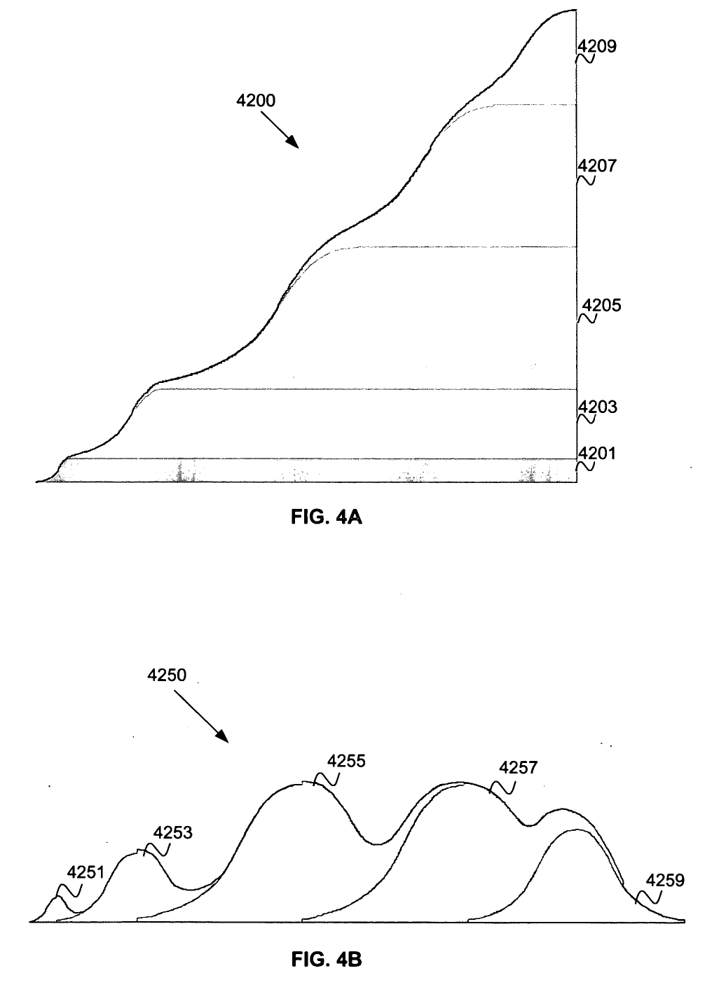

FIGS. 4A and 4B illustrate trend curves used to determine product Adoption Status in the present invention. The cumulative curve 4200 represents expected trends, for example, in cumulative revenues, downloads and customers of a product. Curve 4250 of FIG. 4B represents trends, for example, in new revenues, downloads and customers of a product. Each section 4201-4209 of the cumulative curve 4200 represents different adoption groups. Similarly, sections 4251-4259 of curve 4250 represent those same adoption groups. Sections 4201 and 4251 represent the Innovators. Sections 4203 and 4253 represent the Early Adopters. Sections 4205 and 4255 represent the Early Majority. Sections 4207 and 4257 represent the Late Majority adoption group. Sections 4209 and 4259 represent the Laggards group.

It will be appreciated that the curves illustrated in FIGS. 4A and 4B do not represent complete and accurate views of every product or service. Indeed, many factors, such as environment, seasonality, etc., can affect the shape of each curve. However, using statistical data analysis methods such as, for example, Chi-square, Kolmogorov-Smirnov, correlation testing and regression analysis, the overall trends of each curve may be identified. Furthermore, the adoption group names used herein are for illustrative purposes only. Embodiments of the invention are not limited to the number and the respective characteristics of the defined adoption groups. It is important to realize that the characteristics assigned to each group vary between groups and may vary between same adoption group types (e.g. Early Adopters) for different products and services. The goal of the PDS is to provide targeted customer testing and evaluation of a specific adoption group.

An embodiment of the identification of adoption groups, such as may be performed at block 2802 of FIG. 2, is now described in more detail. Sales figures over time will have peaks (local maxima) as an adoption group begins to fade and troughs (local minima) as a new adoption group emerges. A reliable way of identifying peaks and troughs can help tracking the life cycle of the adoption groups.

Initially, a first peak is identified. The daily changes in sales are used to estimate the slopes and second derivatives of the sales figures. For any day the change in sales for that day as well as the changes for a specified number of previous and following days (moving window) are taken into account. Linear regression is used to fit a straight line through the daily change figures. The values on the line represent smoothed slopes and the slope of the line represents an estimate of the second derivative for the day of interest. The set of daily changes used in the linear regression shifts by one every day. A necessary condition for a peak is for the smoothed slope on the previous day to be positive and the smoothed slope on the following day to be negative. Additional tests can be performed to make sure that insignificant peaks (noise spikes) are ignored. Cumulative sales and the magnitude of the second derivative can be used for that purpose.

Once a peak has been found, the smoothed slopes and second derivatives can be used to find a trough. The sales figures can be analyzed concurrently to see if they are tapering off to a low value rather than leading to a trough. In that case, it is likely that the following adoption group will not emerge. Additional checks can be implemented to deal with the cases when there is no one-to-one correspondence between an adoption life cycle and a peak-trough pair.

Customer emphasis can be estimated by aggregating customer feedback by category and computing the proportion of total feedback for each category. The resulting vector (list of proportions) can be used as a representation of customer emphasis. The customer emphasis vector can be viewed as a point in multi-dimensional space. During the lifecycle of the product the point will move from an initial position to a final position. The initial position, the final position, and the connecting path can be a function of the product and the feedback mechanism (including the specific feedback items for each category). Viewed in this way the customer emphasis vector is also a representation of Adoption Status.

A customer emphasis vector can be determined for every point (or interval) of the lifecycle curve in FIG. 4B. It is then possible to use correlation to determine the similarity of the customer emphasis vector at a given point (interval) to the corresponding vectors at neighboring points (intervals). Each “bulge” (a large interval on either side of a peak) in FIG. 4B denotes an interval of high similarity between customer emphasis vectors. Each trough in FIG. 4B denotes an interval of rapid change or low similarity between customer emphasis vectors. The resulting curve of similarity values may closely parallel its corresponding FIG. 4B curve. Thus, a variation of the peak detection method described above can be applied to the customer emphasis vector similarity curve to corroborate adoption group behavior derived from sales data (i.e. quantitative data).

Alternatively, peak detection can be used on a curve derived by multiplying sales data with the corresponding similarity values. As mentioned above, special handling will be needed if sales are tapering off. Once an adoption group has been identified with the methods described herein, some data can be stored in a database for uses that will be described below. For every product there will be a list of adoption groups. For each adoption group the following data may be stored: trough to trough revenue, trough to trough duration, a few key feedback aggregates (unless they can be easily retrieved from the existing databases), and the representative customer emphasis vector. The representative customer emphasis vector can be derived from the values attained in the high similarity interval for the adoption group. The representative customer emphasis vectors for the final adoption groups for different products can be used in estimating a final customer emphasis vector to be used in the following section. A few conditions need to be satisfied to ensure the validity of the methods described above. First, the customer feedback can be generated by a subset of the customers whose sales data is represented in FIG. 4B. Second, when matched to sales data, the feedback can be dated based on purchase date rather than feedback origination date. Third, the delay between purchase and feedback can be short enough to perform data acquisition in a timely fashion.

When the current product in consideration reaches the interval within an adoption group where neighboring customer emphasis vectors show high similarity, a representative customer emphasis vector X can be estimated. The adoption group and customer emphasis vector data collected according to the specifications described above can be used along with X to estimate the representative customer emphasis vector Y for the next adoption group. Then, an emphasis vector can be generated for each customer in the database (or subset of the database) and its similarity to Y can be determined. The set of customers whose emphasis vector has the highest similarity to Y can be selected for the next evaluation round. A threshold percentage of customers, number of customers, or similarity value can be applied for the selection of customers based on highest similarity to Y. Even though the similarity to Y may not be an estimate of the Probability of Adoption, it is sensible to assume that the Probability of Adoption can be viewed as a monotonically increasing function of the similarity to Y. In the case that there is insufficient data to estimate Y based on X, a heuristic method may be needed. If feedback categories are listed in the order described above with respect to FIG. 3, then transition from one category to the next represents (in a fuzzy way) a step forward in time in the lifecycle of the product. Thus, one way to estimate Y from X is to “rotate right” the items in X. To illustrate the meaning of “rotate right”, assume that there are four feedback categories, 1 to 4, with each higher number being more likely in a later adoption of the product. Thus:
If X=[X(1) X(2) X(3) X(4)] then Y=[X(4) X(1) X(2) X(3)].
   Since this is a very rough estimate and there is not necessarily a one-to-one correspondence between feedback categories and adoption groups, a more fuzzy definition of correlation (such as described below) is needed to define similarity between customer emphasis vectors. If X turns out to be very similar to the estimated final user emphasis vector, there may not be a need to plan an evaluation for the next adoption group. Current adoption group customer satisfaction and sales data can also be used to draw the same conclusion.

In one embodiment of PDS, a fuzzy definition of correlation is defined by considering two 4-element vectors:
A=[A(1) A(2) A(3) A(4)]
and
B=[B(1) B(2) B(3) B(4)].
   Two new 4-element vectors are defined in the following way:
U=[A(1)+r A(2) r A(1)+A(2)+r A(3) r A(2)+A(3)+r A(4) r A(3)+A(4)]
and
V=[B(1)+r B(2) r B(1)+B(2)+r B(3) r B(2)+B(3)+r B(4) r B(3)+B(4)],
   for some constant 0<r<1. In one embodiment, r is about ⅓. The standard definition of correlation between U and V will be used to evaluate the fuzzier correlation between A and B.

Linear regression can be used on previously acquired adoption group data, as described above, to determine the relationship between representative customer emphasis vector components (possibly taking into consideration other items such as customer satisfaction and total feedback) and other items such as: the number of remaining adoption groups for a product, the expected revenue from each remaining adoption group, and the expected duration of each remaining adoption group. The expected revenue from each remaining adoption group is an estimate of the future revenue stream. The expected durations, along with the revenue estimates, can be used to estimate ROI. If the collected data (as described above) is insufficient, an alternate approach may be needed to obtain the estimates.

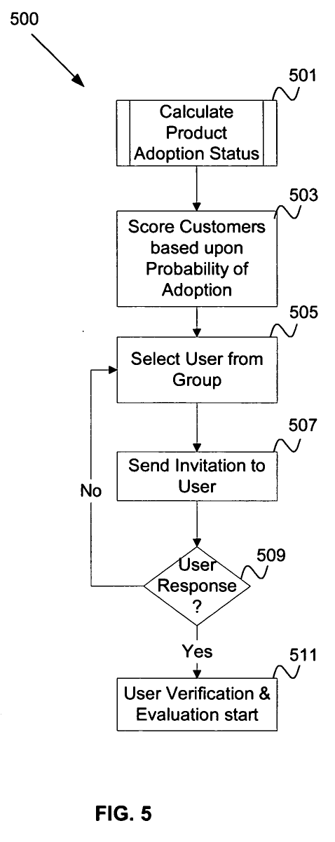

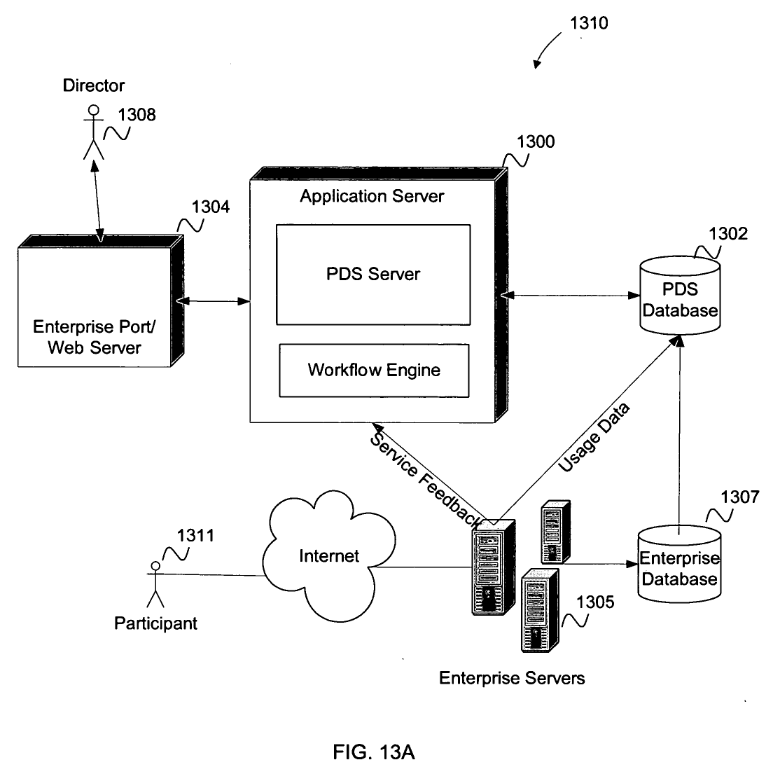

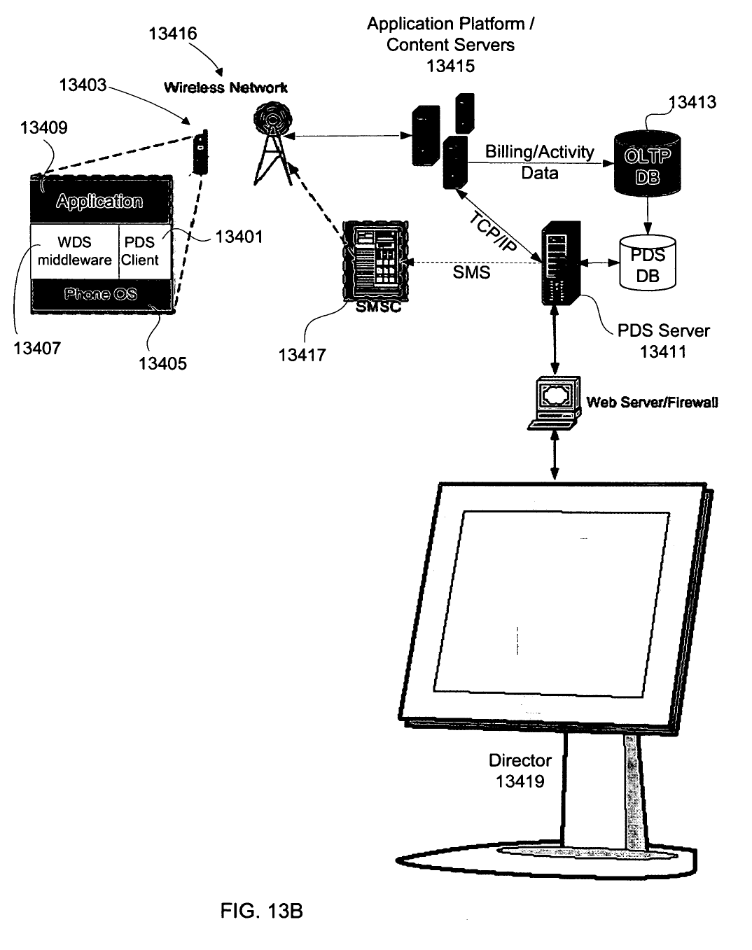

Referring to FIG. 5, an embodiment of the evaluation participant selection process 500 is shown in greater detail. In one embodiment, process 500 represents the processing performed by the PDS 2800 at block 2804 of FIG. 2 to trial a target product with a selected Adoption Group. The process 500 is initiated 501 by determining the Adoption Status of the product to be evaluated as described above. The PDS system searches the enterprise database for customer (or user) information such as feedback provided to the organization about their interests, as well as past history of usage and customer purchase information for other products/services. Using this information, the system determines the customers' Probability of Adoption 503 as described above. Based upon this probability, the PDS system selects 505 a predefined number of customers whose Probability of Adoption exceed selected probability threshold (as determined by a trial director, such as director 1308 described below with respect to FIG. 13A) for participation in an evaluation trial of the product. Invitations to participate in the trial are sent 507 by the system to the user using selected (or available) communications mechanism (e.g. electronic mail, telephone, or mail) whereupon the user is invited to download/use the evaluation product. If a response is not received 509 after a predetermined time period, the user may be replaced by another user from the group 505 by an evaluation user control process such as that described below. If the user responds 509 to the invitation, the system verifies the user and enables 511 permissions for the user to download or access the product.

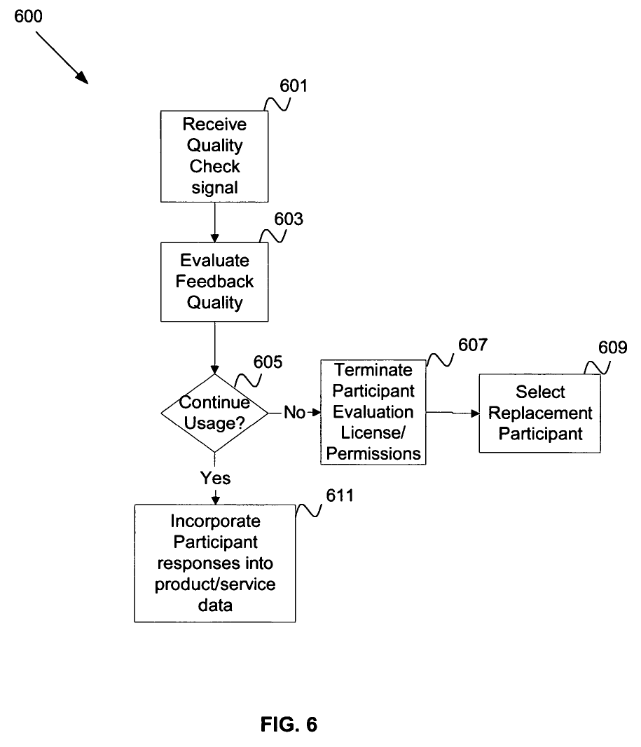

Referring to FIG. 6, an embodiment of the evaluation participant control process 600 is shown in greater detail. In one embodiment, process 600 represents the processing performed by the PDS 2800 at block 2806 of FIG. 2 to evaluate usage and feedback. In one embodiment, the process is initiated 601 when a signal is generated either internally by the PDS system or as a result of having received feedback from a participant. The process 600 evaluates 603 the quality of the feedback from the participant. This quality factor is based upon a calculated diversity index for the range of the participant's feedback using well-known statistical functions, including but not limited to entropy analysis functions, binomial and normal distribution functions. Additional integrity checks are used to ensure consistency in the responses from the participant. Similarly, the timeliness of the participant feedback contributes to the quality factor, as the number of responses, and “burstiness” of the responses from the participant are statistically analyzed. The process 600 also uses peer group statistical analysis to compare a particular participant's feedback to that of the feedback from other members of the evaluation group. PDS also maintains a calculated accuracy score for each participant in predicting post-launch performance to manage participant quality in the evaluation.

Additional details of participant evaluation and selection for one embodiment of the PDS are now described. In one embodiment, the selection criteria for selecting a participant includes evaluation of 1) usage and attrition, 2) burstiness, 3) feedback and coverage, 4) number of N-tuples, and 5) outliers.

Usage is simply the sum of session lengths during a time interval divided by the length of that time interval. If we use fixed time intervals throughout we only need to compute the sum of session lengths. One possibility is to define usage measured on any day as the sum of session lengths during the preceding week. Attrition can then be determined using the ratio of usage computed on a given day to the usage computed at the end of the first week of the trial. A lower ratio represents higher attrition. The feedback of participants with the highest attrition can be excluded from further analysis. If a participant's usage after the first week is too low, his/her feedback could be excluded from further analysis regardless of attrition.

In one embodiment, burstiness is another criteria for selection. For every response, the time elapsed from the previous response (from the beginning of the session for the first response) is associated with that response. Responses whose time interval is smaller than a certain value are considered to be part of a burst of responses, and thus are referred to as “bursty” responses. If the ratio of bursty responses to total responses exceeds a certain threshold value for a given participant, the feedback from that participant could be excluded from further analysis. For example, bursty responses could indicate that the participant is simply trying to fill in the form as fast as possible, and not necessarily reflecting upon the questions asked before giving a thoughtful reply.

Feedback coverage is another criterion. Feedback can be split by category, function, level, screen and other criteria. Each response can be assigned to a corresponding N-tuple. A participant providing responses for a greater number of N-tuples may be considered a more “conscientious” participant. The feedback from participants responding to too few N-tuples may be excluded from further analysis. Too many responses for a given N-tuple may also be an indicator of a “trigger happy” participant. If a participant's number of responses for any N-tuple exceeds a certain number, the feedback from that participant may be excluded from further analysis. In many instances, using criteria such as the number of N-tuples and the number of responses for a given N-tuple, will result in the selection of participants whose N-tuple distribution has higher entropy.

Another criteria for selection relates to outliers or dissimilarity to other members of the group. Responses can be accumulated per N-tuple for any group and for participants within that group. The correlation of the individual's responses to the aggregates for the group can be used as a similarity measure ranging from 0 to 1. Participants whose similarity to the group is too low may be adding noise to the aggregates, and their feedback may be excluded from further analysis.

In another aspect, thresholds may be specified and applied using the PDS. In one embodiment, three specific measurements are used to specify thresholds for any of the selection criteria above. The first is an absolute number or ratio. For example, with respect to feedback, if the number of N-tuples from a participant is less than a specified threshold value, the participant's feedback would be excluded from further analysis. The second is a percentile relative to other participants. For instance, with respect to feedback, if a participant's number is less than the number for 95% (or another threshold) of participants in the group, the participant's feedback would be excluded from further analysis. The third is a combination of the previous two. A participant's feedback is excluded if both of the previous thresholds indicate it should be excluded. For example, with respect to feedback, if the participant's number of N-tuples is less than a specified threshold number and is also less than the number of N-tuples from a given percentage of participants in the group, the participant's feedback would be excluded from further analysis.

The selection criteria specified above are merely exemplary, and it will be appreciated that other criteria can be selected. If a participant is excluded based on a given criterion, the exclusion is noted but the participant may still be included in the other selection tests. This is done to ensure that the selection tests are commutative when the second or third thresholding method is used. Furthermore, one thresholding method can be used for one selection test, while another method can be used for a different test type. In one embodiment, any of the selection tests can be enabled or disabled.

The exemplary heuristics used to determine if participant should be excluded from the trial are meant to illustrate an embodiment of a “hard” decision approach. “Soft” decision approaches can also be used in certain embodiments, whereby the participant is “de-weighted” and the data collected from such participant is accumulated or aggregated according to its weight and associated value to the trial.

In one embodiment, aggregates may be evaluated based upon usage, attrition, feedback convergence, and by tracking changes. Usage and attrition are measured for aggregates in the same way as described above for selection criteria of individual participants. A high attrition is used as an indicator of lack of sustained interest in the product.

Feedback convergence is determined from the responses of two adjacent time periods. Correlation is used as a measure of similarity between the two periods. If the correlation exceeds a specified threshold the feedback from the group is likely converging. The N-tuples with the greatest response count are likely to be most important. If convergence is established there is greater confidence that the top N-tuples represent items requiring attention.

If the feedback convergence approach does not indicate convergence, it may be worthwhile to find out which N-tuple response count is changing more significantly. The proportion of responses of an N-tuple to the total is computed for all N-tuples in two adjacent periods. For each N-tuple the difference in proportions between the two periods is computed and the N-tuples with the greatest change in proportion are displayed. As an example, consider three N-tuples defined for a political office election as Candidate A, Candidate B and Undecided. The proportions and the resulting differences are:

| | PERIOD 1 | PERIOD 2 | DIFFERENCE |
|---|---|---|---|
| Candidate A | 47% | 44% | −3 |
| Candidate B | 46% | 44% | −2 |
| Undecided | 7% | 12% | 5 |

Period1 and Period 2 designate two samples separated in time. This particular example demonstrates that the most notable change of 5 percent points would have occurred for the Undecided N-tuple.

Referring again to FIG. 6, based upon the quality scoring as determined at block 603, the process 600 determines 605 whether the participant's feedback is suitable for incorporation into the overall evaluation results, as well as the desirability to retain the participant as part of the evaluation. If the process 600 determines that the participant should be removed, then the participant's permissions/license for the product may be revoked 607 and the participant's participation in the evaluation terminated. The process 600 can optionally select a replacement participant 609. If the quality of the participant's feedback is determined to be of suitable quality, then the results may be incorporated 611 into the overall results for the evaluation group.

Therefore, in one embodiment, the PDS system can maintain the size of the desired participant pool through the later addition of new participants due to the removal of participants based upon the quality of their feedback. Additionally, the PDS system can identify and recruit new participants to replace customers who were initially selected to participate, but failed to respond to the invitation. In one embodiment, the PDS system also allows the modification of the selection criteria at any point of the evaluation process.

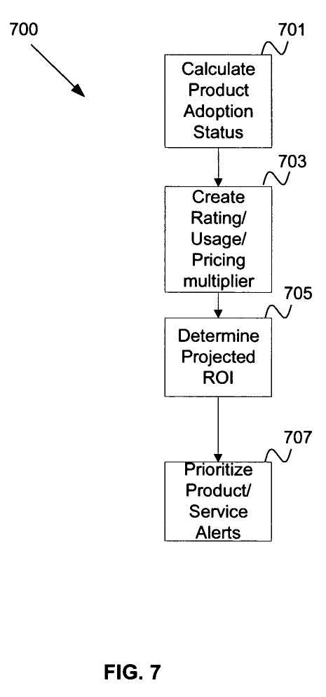

In an embodiment where a PDS system is used to simultaneously manage multiple products and services together, a system of prioritized alerts can be used to prioritize information delivered to the organization. This system of prioritization is based upon parameters which include, but are not limited to marketplace status of the product, evaluation and usage metrics, pricing information and projected revenues or return on investment (ROI) for a given timeframe. Referring to FIG. 7, an embodiment of an Alert Prioritization process 700 is described. In one embodiment, process 700 may be used by a PDS system, such as that described with respect to FIG. 2. The process 700 is initiated by determining the product lifecycle status 701, such as by analyzing trends as described above with respect to FIGS. 4A and 4B. Rating and usage data from the evaluation of the product, such as that obtained through process 600 described with respect to FIG. 6, is used to create a multiplier 703. This multiplier is used in conjunction with pricing information of the particular product to project revenues or ROI for the product for a given timeframe 705.

Other multipliers may be used separately or in combination to provide more accurate forecasting. These may include a request multiplier which can be used to forecast demand based upon the number of requests received through PDS from participants. For content management, calculated historical multipliers for content groupings can also be used to forecast demand. In one embodiment of PDS, a content service such as a video on demand service might combine rating data with requests for a particular movie, as well as historical download data for actors in the movie, the director of the movie and the movie genre to generate a forecast for expected downloads for this movie. This forecast can be used to plan for managing traffic capacity once the movie has been released on the service. In addition, traffic mitigation strategies such as caching or preloading content to end-user devices can be employed to optimize the network for additional network traffic resulting from the newly offered movie.

Using this revenue/ROI as a score, any product alerts which are transmitted to the organization are prioritized 707. For example, in one embodiment, this would permit an alert for a product that is more valuable to an organization to be prioritized over an alert for a product that is less valuable to the organization.

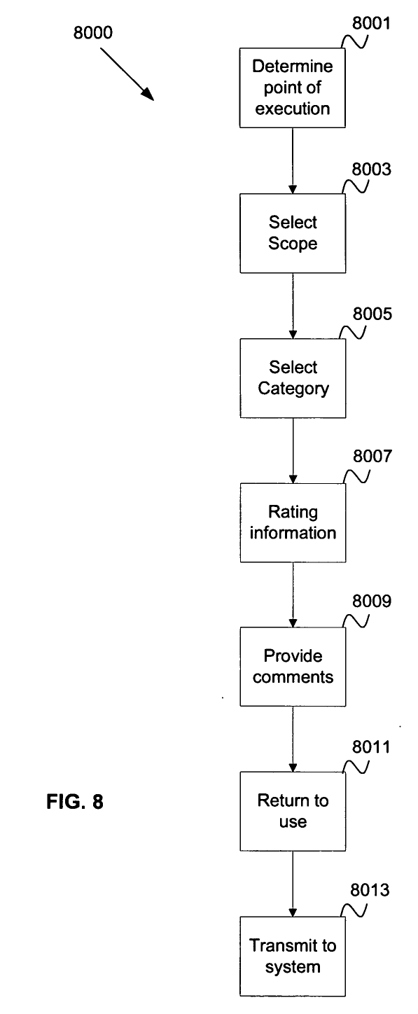

Referring now to FIG. 8, an embodiment of the participant feedback process 8000 is shown in greater detail. In one embodiment, process 8000 represents a portion of the processing performed by the PDS 2800 at block 2804 of FIG. 2 to obtain participant feedback. The process 8000 is initiated by the participant at any point of during usage or evaluation of the product. This initiation may be represented by a keystroke, menu selection, hyperlink, or any other means used to provide input to a software application. The point of execution of the product is determined 8001 by the system. Point of execution can be defined as that point in the execution of the offering where the participant suspends active execution of the offering to provide feedback, as may be represented by a specific point of executable code including any stored context information up to that point. The participant provides scope information 8003 to the system regarding the scope of the feedback being provided by the participant. Such scope may include, but is not limited to the overall scope of the product, a particular level, screen, feature or function. The participant may also provide category information which defines the nature of the feedback to be provided 8005. These categories may include defects, which include but are not limited to function, feature, quality, value, usability or a suggested enhancement for one of the same categories. The participant may provide a rating associated with the above parameters, which may be represented using a numeric input, scale or icon 8007. Comments may be added by the participant 8009, either in the form of free-form text or as one of multiple options for the participant to select. The participant may choose to return to using the product 8011. The process 8000 transmits 8013 the collected data for processing to a PDS server, such as PDS server 1300, which is described with respect to FIG. 13A below. The process 8000 may be invoked at various points throughout a participant's evaluation or use of a product. The feedback process 8000 may be initiated multiple times over a participant's evaluation or use, and may utilize a variety of response mechanisms including voice, such as for example Voice eXtensible Markup Language (VXML), a specification for accessing voice recognition software via the Internet. In another embodiment of the participant feedback process, a survey may be transmitted to the participant for completion, based upon an internal mechanism within the PDS system. In one embodiment of the PDS, a proprietary communication protocol is used between the PDS client and PDS server in which the registration, feedback and usage data are encoded by the PDS client and transmitted to the PDS server. Upon completion, the survey form would be returned to the system for processing. In one exemplary embodiment in which a PDS system is used to evaluate a software product, a survey may be emailed to a participant as a means to provide feedback, rather than having the participant to provide feedback through the software application itself.

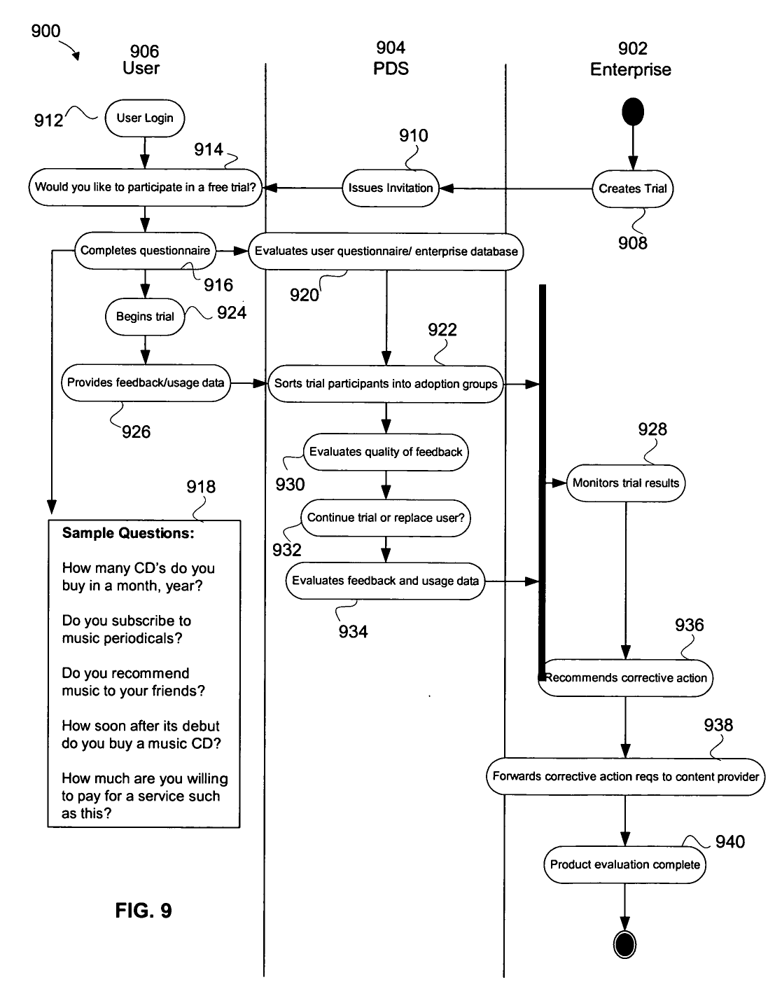

By way of example, an embodiment of a PDS system used to measure usage and satisfaction among prospective customers of a music product is described with respect to FIG. 9. In one embodiment, the flow 900 illustrated by FIG. 9 represents a particular example of the processing performed by the PDS 2800 of FIG. 2. Initially, the enterprise 902 creates a trial 908 for a particular product. The PDS 904 then issues invitations 910 to prospective participants 906.

After a prospective participant 906 logs into 912 the PDS, for example, through a web site, the prospective participant 906 is asked whether they would like to participate in a free trial 914. Prior to beginning the trial, the prospective participant completes a questionnaire 916. Sample questions that may be included in the questionnaire are illustrated at block 918. The participant may begin the trial of the product 924. For the period of evaluation, the participant 906 can provide feedback 926 to the enterprise 902 such as rating information, as well as detailed feedback at various points of the product or service. This can be accomplished either through a “push” mechanism integrated with the product or service, or a periodic “pull” mechanism where a survey is sent to the participant.

The PDS 904 evaluates the responses to the questionnaire 920. Based on the questionnaire 920 results and the feedback and usage data 926, the PDS sorts the prospective trial participants (users) 906 into adoption and/or demographic groups 922. Where no prior demographic information exists for a participant, this participant may be temporarily assigned to a default group. As demographic information is gathered from this registration step, the participant can be assigned to a more specific group based upon the granularity of the demographic information gathered from them. In this way, PDS builds groups in a dynamic way. These groups can also be hierarchical depending on the level of detail required by enterprise. Thus, any participant can belong to a parent group and all subgroups of greater granularity to which they belong. In one embodiment, a random participant for whom there is no prior demographic information might be invited to participate in an evaluation. Upon completion of the questionnaire during registration, this participant might be assigned to a group called Single Males. In addition, this participant might also be assigned to a group called Singles Male, Income>$150,000 either immediately or at some point in the future. In this way, this user can be used as a data point for both groups depending on the level of detail required by the enterprise. The PDS system 904 allows an enterprise 902 (business organization) to select participants 906 (users) for evaluation of a product based upon demographic information such as age, address, gender and income, as well as adoption group information, which defines customers in terms of when they are likely to adopt this particular product. Where such data does not exist for the user 906, in particular the adoption data, as may be in the case for a new class of product or service, this data can be generated based upon completion of a questionnaire 918 during registration by the user 906 for the evaluation phase. Purchase history for similar products and services may also be used to predict this point of adoption. The PDS 904 uses this and other data to characterize the responses from each participant, and their subsequent applicability to PDS. Therefore, PDS allows the selection of participants based upon the likelihood of that participant to purchase a product such as the one to be evaluated at a given point in its lifecycle.

The PDS 904 examines the quality of feedback 930 from each participant in order to determine both the value and applicability of the feedback to the current phase of product adoption. PDS can automatically control access to the product or service based upon quality factors. In addition, it may automatically add, remove and replace participants as necessary throughout the evaluation phase through a license control mechanism 932.

The PDS 904 provides license management 932 specifically for the duration of a product evaluation trial. Through its Trial Management User interface, PDS 904 determines the duration and renewability of licenses granted to participants in a product evaluation trial. In one embodiment, this feature can be implemented as follows. When the participant downloads the evaluation product, the PDS creates a license determined by the initial parameters of the trial, such as start date, utilization metric and end date. When the participant initiates the product (e.g. a software application), the product checks the license permissions stored on the device (e.g. a handset) and the PDS is accessed transparently to determine if this participant can use the evaluation product.

Under certain conditions, such as the participant being removed from the trial because the quality of the feedback is deemed poor, the PDS server can signal to the PDS client that the active license should be deactivated. From this point on, the participant will no longer be able to use the evaluation trial and may be informed that the trial has ended. Similarly, the director can decide to prematurely terminate the trial and by simply stopping the trial in the PDS server, again the PDS server can signal the PDS client to deactivate the license and the trial is terminated. In another example, the license may be terminated prior to the end date if the utilization metric has been satisfied.

Where a trial can be extended and the client license has expired, the PDS client can query the PDS server for a license update. In this case, a new license is transmitted to the PDS client and the trial continues for this participant.

Referring again to FIG. 9, if a participant is not replaced at block 932, the PDS 1304 evaluates feedback and usage data of the participant 906. The enterprise 902 monitors the trial results 928, by considering particular adoption groups 922 and feedback and usage data 934. Once the enterprise 902 has received enough conclusive data regarding the feasibility of the product within a particular adoption group, the enterprise 902 can choose to cancel, launch or take some corrective action 936 with the product based upon the collected feedback 934. Where corrective action is taken, the requirements are forwarded to a content provider for implementation 938. At some point, the product evaluation is then completed 940.

PDS provides key performance indicators (KPIs) to allow the enterprise to monitor the success of its offerings as well as to identify early issues among customer segments with its offerings during evaluation and after launch. In one embodiment of PDS, five KPIs identify the current state of the enterprises' offerings. A downloads/usage KPI shows the level of activity across the entire customer base. This KPI can be generated for the known PDS groups and through inferred membership of these groups for each customer, PDS can break this KPI down to show the download/usage activity for the different segments of the customer base represented by these groups. Similarly, average usage, churn, ratio of requests to usage, ratio of browsing to usage, KPIs can be generated for each PDS group and inferred for the larger group of customers.

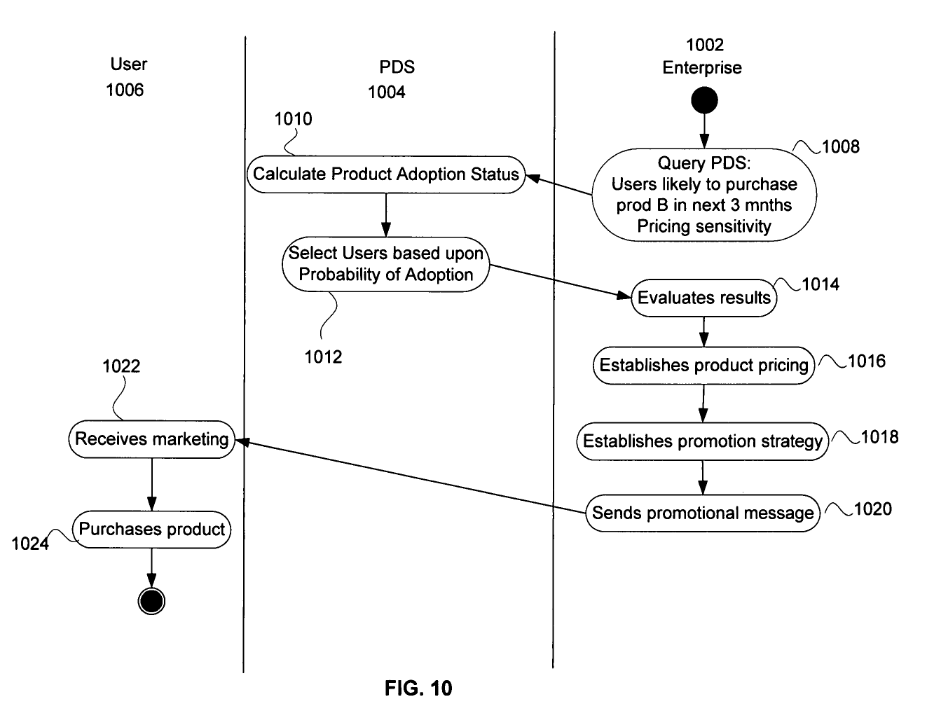

In another exemplary embodiment of PDS, illustrated in FIG. 10, the PDS is used to enable the creation of effective marketing strategy and execution. In one embodiment, the flow illustrated by FIG. 10 represents a particular example of the processing performed by blocks 2812 and 2816 of PDS 2800, illustrated in FIG. 2. The Enterprise 1002 establishes product pricing and promotional channels based upon the demographic, usage and feedback data collected during the evaluation phase. Once completed, PDS 1004 is queried 1008 for a priority list of prospective customers (users) based upon the calculated likelihood of the user to purchase the product in the given timeframe 1010. Users are then selected based upon their probability of adoption 1012. The Enterprise 1002 may evaluate the results received from the PDS 1014, establish product pricing 1016 and a promotion strategy 1018. A promotional message might be sent 1020 to the user 1006 with special promotional pricing which reflects the pricing sensitivities of the adoption group as established from the evaluation. After receiving the marketing 1022, the user may purchase the product 1024.

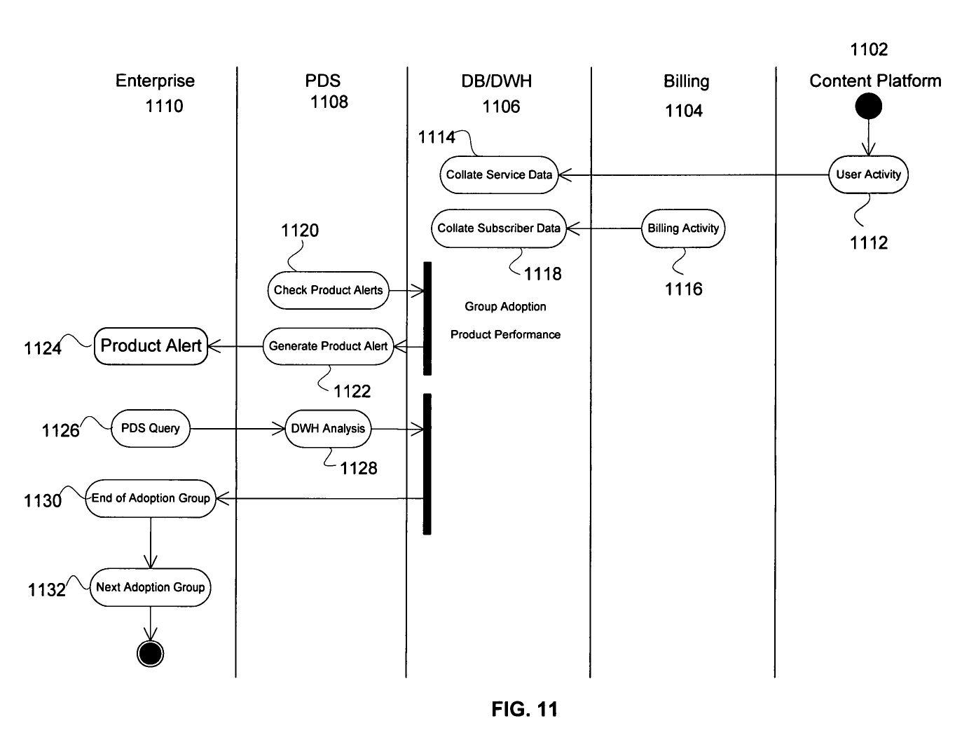

In another embodiment of the PDS illustrated in FIG. 11, PDS 1108 is used for product performance monitoring. In one embodiment, the flow illustrated by FIG. 11 represents a particular example of the processing performed by block 2814 of PDS 2800, illustrated in FIG. 2. As activity data 1112 is received from the content platforms 1102 and billing activity 1116 is received from billing systems 1104, PDS 1108 collates this data internally in a database and data warehouse 1114, 1118 processing it for analysis, reporting and data-mining functions. PDS 1108 performs many internal checks to determine the status of product adoption 1120 using various parameters such as downloads, subscribers, usage, revenues and chum.

Where PDS 1108 detects that the product has reached saturation in this adoption group, an alert is generated 1122, 1124 for the adoption group and sent to the enterprise 1110. After querying the PDS 1126, the enterprise performs subsequent analysis 1128 of the Subscriber, usage and any feedback data stored in a data warehouse. The enterprise 1110 may determine that the current adoption group has been fully penetrated 1130 and turns their focus to the next adoption group 1132.

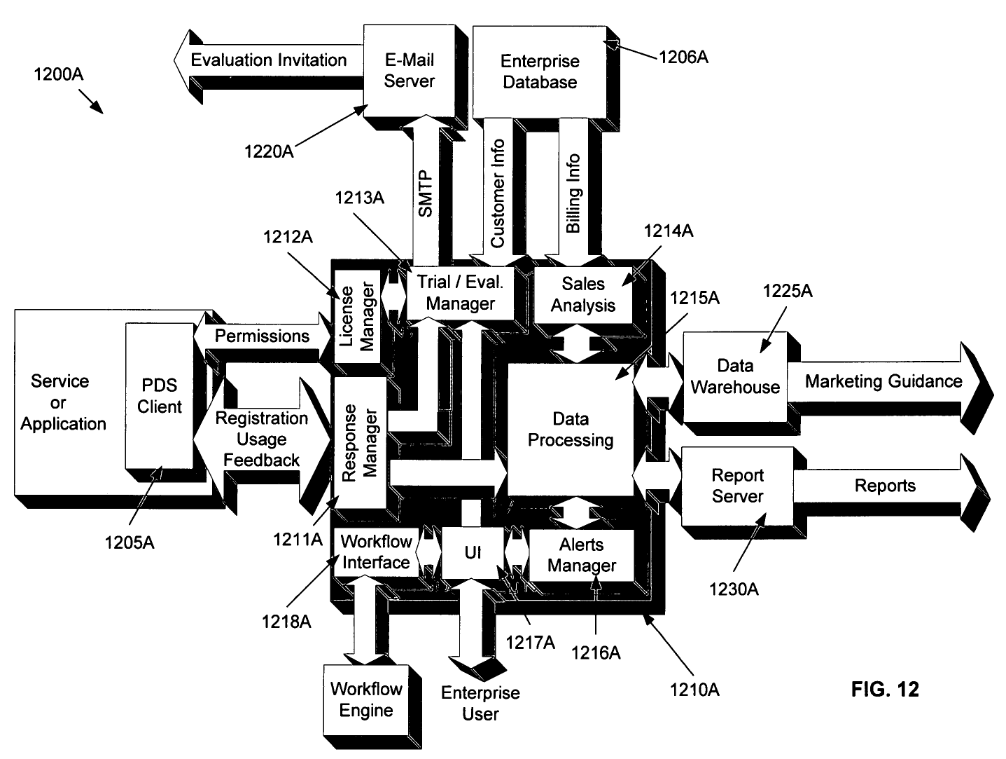

FIG. 12 illustrates an embodiment of a Product Decision Support (PDS) system 1200A and its components. The PDS client 1205A is a multi-language library which can be embedded into special releases of offerings to be evaluated. The PDS client 1205A is responsible for gathering participant registration information, usage information and feedback from participants through its simplified user interface which also captures the context of this feedback. It is responsible for transmitting this data to the PDS server 1210A via the response manager 1211A. The PDS client 1205A is also responsible for controlling access to the application by evaluation participants through communication with the license manager 1212A.

The PDS license manager 1212A is responsible for managing permissions associated with products and services under evaluation and communicating this to the PDS client 1205A. The trial/evaluation manager 1213A communicates with the license manager 1212A to determine those users which are permitted to use a product or service. This determination is part of the authentication and authorization process. The response manager 1211A can disable user licenses when it detects quality issues regarding a participant's feedback or usage of the product or service. In one embodiment, the license manager 1212A performs at least a portion of the processes described above with respect to block 932 of FIG. 9.

The PDS response manager 1211A is responsible for monitoring the quality of the data received from each participant. This quality can be determined by the number of uses, average usage time, diversity of feedback, regularity of feedback, as well as consistency with the participant's peer group. These factors are used to determine if responses should be included for processing and/or whether the participant should continue as part of the trial. If so, the PDS response manager 1211A communicates this to the trial manager 1213A which manages and controls user participation.

The PDS trial/evaluation manager 1213A is responsible for managing trials as well as selecting, removing and replacing participants within the trial. Through demographic and purchase criteria, the director (an enterprise user of the PDS) can direct the trial/evaluation manager 1213A to choose a specific group of users based upon data collected in an enterprise database 1206A. The trial/evaluation manager automatically generates invitations to the users through its interface to an e-mail server 1220A. In addition, the PDS trial/evaluation manager 1213A is responsible for ongoing participant evaluation utilizing real-time contextual feedback and measurement data from the PDS client 1205A to develop and present product and service metrics such as usage and satisfaction.

The PDS sales analysis module 1214A tracks revenue data for products and services after launch to track performance as well as when market shifts occur and generate appropriate alerts. These shifts may signal the need for adjustments to a product or service and/or its marketing. In order to track the lifecycle status and projected lifetime value/usage of the offering, PDS characterizes customers based upon the similarity of each customer to the known demographic/adoption data collected from trial participants during registration and feedback data. This characterization can be based upon known demographic data or a calculated probability of similarity to the evaluation groups based upon prior usage.

The PDS data processing module 1215A collates data received from both evaluation and sales data. It interfaces with the alerts manager 1216A to generate metric-specific alerts either during evaluation or post-launch. The data processing module 1215A also interfaces with the data warehouse 1225A and report server 1230A to provide marketing guidance and reports to the director (enterprise user of the PDS).

The PDS alerts manager 1216A is responsible for managing all alerts during both the evaluation and post-launch stages of a product. The director interface module 1217A is a web-based user interface (UI) which allows the director to control and view alerts, trials and trial information, generate reports, data-mine collected data and interface with any workflow function. The PDS workflow interface module 1218A supports optional integrated workflow tools to automate the steps necessary for successful PDS operation.

FIG. 13A illustrates an embodiment of a particular implementation of a PDS, and its logical arrangement of communications mechanisms for the PDS system 1310. It will be appreciated that the details of the communications mechanism on which the PDS system 1310 is implemented may vary. The Product Decision Support (PDS) system 1310 is deployed in an Internet Service environment, comprising an application server 1300 running the PDS server and a workflow engine, a relational database 1302 including PDS information such as user information, as well as result and rule sets, a web server 1304, which serves as a portal for digital products and services. A portal may be defined as a major starting site for users of the World-Wide Web, Internet, or any other communications network.

Participant 1311 is an evaluation participant which generates feedback or responses to surveys. Director 1308 is a member of the enterprise or organization, such as for example, a member of Marketing, Sales, Customer Service or Human Resources. In one embodiment, director 1308 uses the PDS to initiate, monitor, or conduct evaluations, or any combination thereof. A relational database 1307 stores information about the organization's group of users and activities, evaluation data collected from the PDS client as well as product metrics such as downloads and usage for deployed products from billing databases, as well as product-specific parameters and metrics for customizable data collection and processing. The PDS system 1310 may also include an enterprise server platform 1305 which may host products, services and a communications system. In one embodiment, participant 1311, web server 1304, PDS server 1300, relational database 1302, director 1308, enterprise server platform 1305, and relational database 1307 are coupled to a communications network, such as a Wide Area Network (WAN), e.g., the Internet, or a Local Area Network (LAN), e.g., a private intranet.

In another embodiment, a PDS is deployed in a Wireless Data Services (WDS) environment as illustrated in FIG. 13B. In such an embodiment, the communications mechanism is composed of wireless network elements used to facilitate data communications. These include but are not limited to a Base Station Controller (BSC), a Mobile Switching Center (MSC), an Interworking Function (IWF), Packet Data Serving Node (PDSN) or a Short Message Service Center (SMSC). As part of this embodiment, the PDS system consists of a client 13401 which resides on a mobile device 13403 along with the Phone OS 13405, application middleware 13407 and applications implementing products and services 13409. In another example, the PDS client 13401 can be integrated into the PDS Server 13411. The system also includes the means which may be used to provision, deliver and execute products in a given deployment. These may include application/content servers 13415, provisioning servers 13415, billing systems and databases 13413 as well as the client middleware 13407 and applications 13409 which use this middleware 13407. The proposed system also includes the parts of the wireless network such as the handset operating system 13403, radio network 13416 for communicating between the handset 13403 and the wireless network and a messaging system 13417, such as a Short-Message Service Center (SMSC) 13417 for delivering trial invitations to potential participants. When text messages are used for communication purposes, a communications network, such as an intranet, or the Internet connects all the network parts and provides an interface between the PDS server 13411 and the director 13419 including any required operational devices such as routers and firewalls.

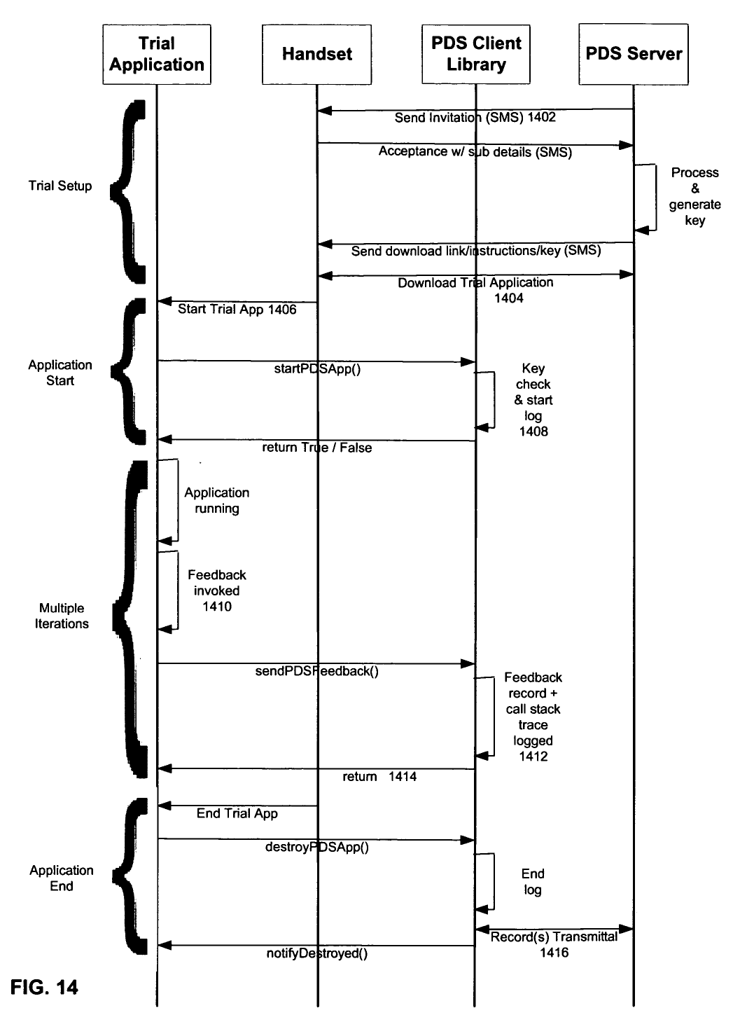

FIG. 14 illustrates an embodiment of a series of interactions within the WDS of FIG. 13B. These interactions represent work-flow and call-flow between the Director 13419 (i.e. an enterprise user of the PDS), PDS server 13411, wireless handset 13403, PDS client 13401 and the trial product 13409. Data received from the billing database 13413 might cause the PDS to generate an alert based upon declining metrics such as customer downloads, revenues, or usage for an existing product (application 13409). Alternatively, a new or revised product might cause a director to unilaterally decide to have the product evaluated before determining whether it should be launched to the targeted (based on the adoption point) prospective customers. In either case, the director might provision an evaluation release of the product (application 13409) on the PDS system. This evaluation release (trial product) would either directly incorporate PDS client functionality or calls to PDS client functionality, which may already exist in the application middleware 13407 shown in FIG. 13B

Once this special product release has been provisioned on the PDS system, the director can define the trial by choosing criteria to determine how many participants and which demographic and adoption criteria, if any, should be used by the PDS Server when it randomly selects possible participants for the product evaluation. Once selected, the PDS Server sends trial invitations 1402 using SMS or some equivalent messaging mechanism, to send an invitation to the potential participants to download the evaluation version of the trial product from the provisioned location. Upon verification by PDS of any persons attempting to download 1404 such trial versions, PDS also provides a trial license for the purpose of controlling and managing participants in the trial. Where such licenses expire but are deemed renewable, the PDS client will request a new license from the PDS server and update it if permitted. Alternatively, if it is not permitted, then the product evaluation will terminate for this participant and they will no longer be able to use the trial product. Similarly, if at any point PDS removes this participant for quality reasons from the trial or the director decides to terminate the trial prematurely, this license can be overridden and deactivated on the handset.

Once the product has been successfully downloaded and started on the handset by the participant 1406, the PDS System tracks information about the participant's usage of the product 1408, which may include usage times, patterns, etc. While using the product, the participant can at any time invoke a feedback mechanism 1410, such as a menu item or a soft key and through a series of simple selections provide context information about such feedback as well as information such as satisfaction/rating metrics and comments about the item. Internally, PDS tracks the location in the product where the feedback was provided 1412, and later on correlates this location with the context and feedback when the results are processed by the PDS server. Once the participant has completed the feedback, they can return 1414 to using the product at the point at which they invoked the feedback menu. The participant can repeatedly invoke such feedback at the same or different points of the product. In each case, PDS can either transmit such feedback to the PDS server for processing or store the feedback for future transmittal to the PDS server. Once the user completes usage of the product, the PDS client can either transmit the usage information to the PDS server for processing 1416, or store the usage information internally for later transmittal. The transmittal can be done periodically, by a request/response mechanism, event trigger, or scheduled such as the specific time of day to reduce the cost of transmissions, for example.

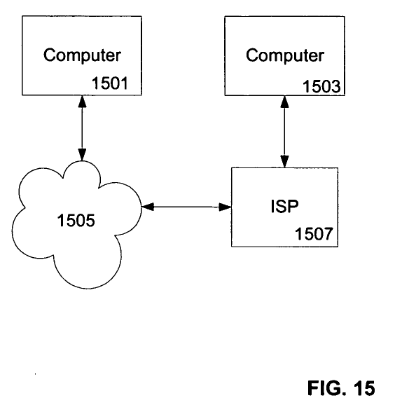

As discussed above, various embodiments of the present invention may be implemented using a network. In one embodiment, as shown in FIG. 15, a computer 1501 is part of, or coupled to a wide area network (WAN) 1505, such as the Internet, to exchange data with another computer 1503, as either a client or a server computer. For example, in one embodiment, the PDS 1300 of FIG. 13A includes a computer 1501 and is part of, or coupled to a network 1505 to exchange data with other computers 1503 (e.g. enterprise servers 1305 of FIG. 13A). Typically, a computer is coupled to the Internet through an ISP (Internet Service Provider) 1507 and uses a conventional Internet browsing application to exchange data with a server. Other types of applications allow clients to exchange data through the network 1505 without using a server. It will be readily apparent that the present invention is not limited to use with a public WAN; directly coupled and private networks are also contemplated, in addition to local area networks (LANs). Embodiments of the invention can also be practiced in distributed computing environments where tasks are performed by remote processing devices that are linked through a communications network.

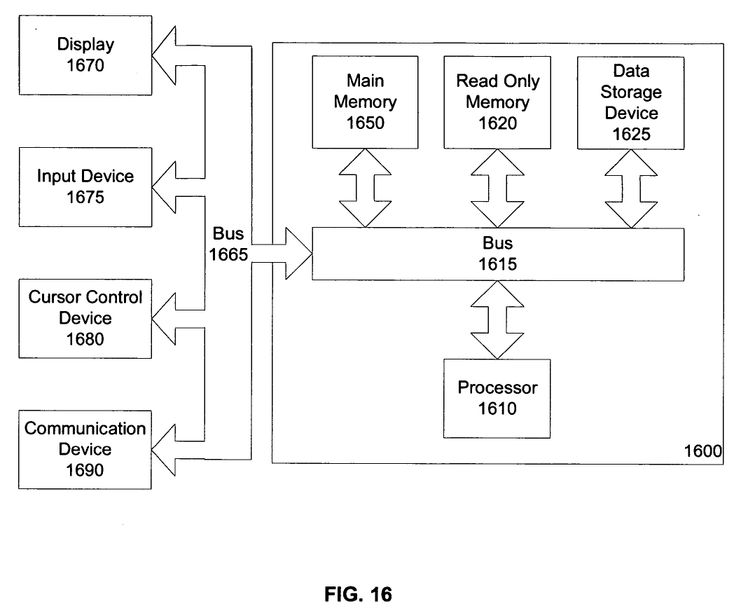

FIG. 16 illustrates an embodiment of a computer system that may be used with the embodiments of the present invention. For example, in one embodiment, application server 1300 of FIG. 13A includes a computing device or computer system similar to that described below with reference to FIG. 16. The data processing system illustrated in FIG. 16 includes a bus or other internal communication means 1615 for communicating information, and a processor 1610 coupled to the bus 1615 for processing information. The system further comprises a random access memory (RAM) or other volatile storage device 1650 (referred to as memory), coupled to bus 1615 for storing information and instructions to be executed by processor 1610. Main memory 1650 also may be used for storing temporary variables or other intermediate information during execution of instructions by processor 1610. The system also comprises a read only memory (ROM) and/or static storage device 1620 coupled to bus 1615 for storing static information and instructions for processor 1610, and a data storage device 1625 such as a magnetic disk or optical disk and its corresponding disk drive. Data storage device 1625 is coupled to bus 1615 for storing information and instructions.

The system may further be coupled to a display device 1670, such as a cathode ray tube (CRT) or a liquid crystal display (LCD) coupled to bus 1615 through bus 1665 for displaying information to a computer user. An alphanumeric input device 1675, including alphanumeric and other keys, may also be coupled to bus 1615 through bus 1665 for communicating information and command selections to processor 1610. An additional user input device is cursor control device 1680, such as a mouse, a trackball, stylus, or cursor direction keys coupled to bus 1615 through bus 1665 for communicating direction information and command selections to processor 1610, and for controlling cursor movement on display device 1670.

Another device, which may optionally be coupled to computer system 1600, is a communication device 1690 for accessing other nodes of a distributed system via a network. The communication device 1690 may include any of a number of commercially available networking peripheral devices such as those used for coupling to an Ethernet, token ring, Internet, or wide area network. The communication device 1690 may further be a null-modem connection, a wireless connection mechanism, or any other mechanism that provides connectivity between the computer system 1600 and the outside world. For example, the communication device 1690 may include coaxial cable, fiber-optic cable or twisted pair cable. Note that any or all of the components of this system illustrated in FIG. 16 and associated hardware may be used in various embodiments of the present invention.

It will be appreciated by those of ordinary skill in the art that any configuration of the system may be used for various purposes according to the particular implementation. The control logic or software implementing the present invention can be stored in main memory 1650, data storage device 1625, or any machine-accessible medium locally or remotely accessible to processor 1610. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.).

It will be apparent to those of ordinary skill in the art that the system, method, and process described herein can be implemented as software stored in main memory 1650 or read only memory 1620 and executed by processor 1610. This control logic or software may also be resident on an article of manufacture comprising a computer readable medium having computer readable program code embodied therein and being readable by the data storage device 1625 and for causing the processor 1610 to operate in accordance with the methods and teachings herein.

The present invention may also be embodied in a handheld, portable, or mobile device containing a subset of the computer hardware components described above. For example, the handheld device may be configured to contain only the bus 1615, the processor 1610, and memory 1650 and/or 1620. The present invention may also be embodied in a special purpose appliance including a subset of the computer hardware components described above. For example, the appliance may include a processor 1610, a data storage device 1625, a bus 1615, and memory 1650, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In other devices, communication with a user may be through the use of audio signals or language, either generated by the machine or spoken by the user.

The description of FIGS. 15 and 16 is intended to provide an overview of computer hardware and various operating environments suitable for implementing embodiments of the invention, but is not intended to limit the applicable environments. A typical device will usually include at least a processor, memory, and a bus coupling the memory to the processor. Such a configuration encompasses personal computer systems, network computers, portable media devices, personal digital assistants, and similar devices. One of skill in the art will immediately appreciate that embodiments of the invention can be practiced with other system configurations, including multiprocessor systems, minicomputers, mainframe computers, and the like.

Thus, a Product Decision Support (PDS) system is a real-time proactive measurement system that allows an enterprise to monitor trends over time to better understand metrics including usage, satisfaction as well as predicting the extent of product/service chum after launch. The PDS allows the director (enterprise user) to select target groups for evaluation using demographic data and purchase history. An integrated client provides a simplified interface to the participant (end user), which assures regular feedback as well as very detailed context information which is specific to each instance of feedback. In one aspect, the PDS ensures that the quality of the evaluation data is always timely, accurate and consistent.

The PDS system automatically selects users for evaluation of a product based upon the marketplace status of the product/service and/or user information which may be obtained directly from the user, from a relational database maintained by the organization, or from some other source. Such databases are frequently deployed throughout organizations and include, but are not limited to Billing systems, Customer Relationship Management (CRM), Human Resource Management Systems (HRMS) and Supply Chain Management (SCM).

The system provides a user interface which may be integrated into the organization's products/services at varying points. Each of these points can be defined as the product/service context. When the participant chooses to provide feedback at any point, they activate the system front-end by selecting the appropriate context, as may be represented by a keystroke, menu selection, hyperlink, or any other means used to provide input to an application. Upon initiation of the user interface a feedback form may be presented. This form may be represented as a set of questions, multiple choice answers, or as a scale or icons describing types of feedback. In addition, the participant may provide free-form comments on the form. The feedback is transmitted back to the PDS system which processes the results. Alternatively, the system may send an unsolicited feedback form to the participant on a periodic basis to solicit feedback about the product or service. As before, the feedback is transmitted back to the PDS system for processing.

Upon receipt of the feedback, the system may process the feedback and determine its quality, validity and value for incorporation into the overall results of the evaluation. Similarly, this quality can be used to determine whether the participant should continue as a member of the evaluation group, thereby controlling access to the evaluation product or service by that participant. Where a participant is removed from the evaluation group, the system may replace the participant with a newly selected member of the evaluation group.

The PDS system creates metrics such as rating/satisfaction, usage and attrition/chum information which can be used to evaluate the likely success among a larger set of users in the marketplace. This includes the generation of detailed corrective action information for products or services which do not achieve the required criteria for the evaluation group.

The PDS system automates of data collection and analysis tasks associated with product and service lifecycle management, including initial and ongoing customer evaluation, product and service performance tracking and management, and corrective action intelligence gathering. The PDS supports iterative evaluation, corrective action and marketing support of products and services targeted to the adoption groups. Although the PDS supports use of demographic variables for selected early Evaluation users, the PDS is not solely limited to this and uses adoption criteria where available for a particular class of product or service, coupled with knowledge of the current status of product/service adoption to identify those participants likely to provide feedback essential to short-term success.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A machine-implemented method comprising:
periodically querying a user in an identified adoption group regarding use of a product;
receiving results of the querying;
evaluating the results, the evaluating including
aggregating the results by category,
computing a proportion of total results for each category, and
generating a first user emphasis vector based on the proportion of total results for each category; and
based on the evaluating, determining whether to incorporate the results of the querying into a representative result for an evaluation group.

2. The method of claim 1, wherein evaluating the results further comprises:
correlating the first user emphasis vector with vectors for neighboring intervals of a lifecycle curve for the product.

3. The method of claim 2, further comprising:
selecting a vector for the neighboring intervals with a high correlation to the first user emphasis vector;
associating the first user emphasis vector with a first adoption status for the product, the first adoption status corresponding to the selected vector; and
estimating a first representative user emphasis vector for the first adoption status.

4. The method of claim 3, further comprising:
based on the first user emphasis vector, the first adoption status, and the first representative user emphasis vector, estimating a second representative user emphasis vector for a next adoption status for the product.

5. The method of claim 3, further comprising corroborating the first representative user emphasis vector with quantitative data of the identified adoption group.

6. An apparatus comprising:
means for periodically querying a user in an identified adoption group regarding use of a product;
means for receiving results of the querying;
means for evaluating the results, the evaluating including
means for aggregating the results by category,
means for computing a proportion of total results for each category, and
means for generating a first user emphasis vector based on the proportion of total results for each category; and
means for, based on the evaluating, determining whether to incorporate the results of the querying into a representative result for an evaluation group.

7. The apparatus of claim 6, wherein the means for evaluating the results further comprises:
means for correlating the first user emphasis vector with vectors for neighboring intervals of a lifecycle curve for the product.

8. The apparatus of claim 7, further comprising:
means for selecting a vector for the neighboring intervals with a high correlation to the first user emphasis vector;
means for associating the first user emphasis vector with a first adoption status for the product, the first adoption status corresponding to the selected vector; and
means for estimating a first representative user emphasis vector for the first adoption status.

9. The apparatus of claim 8, further comprising:
means for, based on the first user emphasis vector, the first adoption status, and the first representative user emphasis vector, estimating a second representative user emphasis vector for a next adoption status for the product.

10. The apparatus of claim 8, further comprising means for corroborating the first representative user emphasis vector with quantitative data of the identified adoption group.

11. A machine-readable medium having instructions to cause a machine to perform a machine-implemented method comprising:
periodically querying a user in an identified adoption group regarding use of a product;
receiving results of the querying;
evaluating the results, the evaluating including
aggregating the results by category,
computing a proportion of total results for each category, and
generating a first user emphasis vector based on the proportion of total results for each category; and
based on the evaluating, determining whether to incorporate the results of the querying into a representative result for an evaluation group.

12. The machine-readable medium of claim 11, wherein evaluating the results further comprises:
correlating the first user emphasis vector with vectors for neighboring intervals of a lifecycle curve for the product.

13. The machine-readable medium of claim 12, wherein the method further comprises:
selecting a vector for the neighboring intervals with a high correlation to the first user emphasis vector;
associating the first user emphasis vector with a first adoption status for the product, the first adoption status corresponding to the selected vector; and
estimating a first representative user emphasis vector for the first adoption status.

14. The machine-readable medium of claim 13, wherein the method further comprises:
based on the first user emphasis vector, the first adoption status, and the first representative user emphasis vector, estimating a second representative user emphasis vector for a next adoption status for the product.

15. The machine-readable medium of claim 13, wherein the method further comprises corroborating the first representative user emphasis vector with quantitative data of the identified adoption group.

16. A system comprising:
a processing unit coupled to a memory through a bus; and
a process executed from the memory by the processing unit to cause the processing unit to:
periodically query a user in an identified adoption group regarding use of a product;
receive results of the querying;
evaluate the results, the evaluating including
aggregating the results by category,
computing a proportion of total results for each category, and
generating a first user emphasis vector based on the proportion of total results for each category; and
based on the evaluating, determine whether to incorporate the results of the querying into a representative result for an evaluation group.

17. The system of claim 16, wherein evaluating the results further comprises:
correlating the first user emphasis vector with vectors for neighboring intervals of a lifecycle curve for the product.

18. The system of claim 17, wherein the process further causes the processing unit to:
select a vector for the neighboring intervals with a high correlation to the first user emphasis vector;
associate the first user emphasis vector with a first adoption status for the product, the first adoption status corresponding to the selected vector; and
estimate a first representative user emphasis vector for the first adoption status.

19. The system of claim 18, wherein the process further causes the processing unit to:
based on the first user emphasis vector, the first adoption status, and the first representative user emphasis vector, estimate a second representative user emphasis vector for a next adoption status for the product.

20. The system of claim 18, wherein the process further causes the processing unit to corroborate the first representative user emphasis vector with quantitative data of the identified adoption group.
